(19) United States
(12) Patent Application Publication
(10) Pub. No.: US 2013/0314285 A1
(43) Pub. Date: Nov. 28, 2013

(54) ANTENNA DEVICE AND WIRELESS COMMUNICATION APPARATUS

(71) Applicant: CANON KABUSHIKI KAISHA, Tokyo (JP)

(72) Inventor: Atsushi Takasaki, Tokyo (JP)

(73) Assignee: CANON KABUSHIKI KAISHA, Tokyo (JP)

(21) Appl. No.: 13/868,834

(22) Filed: Apr. 23, 2013

(30) Foreign Application Priority Data
May 25, 2012 (JP) 2012-120139

(51) Int. Cl. H01Q 9/04

(52) U.S. Cl. CPC H01Q 9/0407
USPC 343/700 MS

(57) ABSTRACT

An antenna device comprises a patch antenna element having a conductor plate, a ground conductor plate provided in opposition to one face of the conductor plate and spaced a predetermined distance away from this face, and a power-supply point for supplying electric power to the conductor plate; and at least one additional conductor plate high-frequency coupled to the ground conductor plate and having a shape that extends in a direction orthogonal to a straight line connecting the center of the conductor plate and the power-supply point.

### BACKGROUND OF THE INVENTION

1. Field of the Invention

The present invention relates to an antenna device and to a wireless communication apparatus that includes the antenna device.

2. Description of the Related Art

Small-size electronic devices including especially personal computers equipped with wireless communication functions such as wireless LAN and Bluetooth (registered trademark) have become widespread in recent years. Radio waves of the 2.4-GHz or 5-GHz band, for example, are used in wireless communication such as wireless LAN and Bluetooth. A personal computer equipped with a wireless communication function has a built-in antenna for wireless communication. Various forms of such antennas are being employed, such as monopole antennas, helical antennas, inverted-F antennas and patch antennas.

These various antennas are necessarily implemented within the limited space inside electronic devices for the purpose of reducing the size of the electronic device and improving the design thereof, and a reduction in cost is required as well. In order to achieve such an improvement in design and reduction in cost, often the antenna is mounted as a component on the same substrate as that of a wireless mobile chip, for example, without the antenna protruding separately from the body of the product, and the antenna is placed inside the body of the product in such a manner that one cannot discern that it is an antenna from the outside. However, in a case where an antenna is built in a small-size electronic device, sufficient space cannot be acquired around the periphery of the antenna and therefore a problem which arises is that the state of antenna resonance is altered by members placed in close proximity to the antenna and hence the frequency characteristic of the antenna when implemented will differ from the frequency characteristic of the stand-alone antenna. Specifically, if metal components exist in close proximity to the antenna, electromagnetic waves from the antenna may induce an electric current in these metal components and the resonance characteristic of the antenna may change owing to the occurrence of unwanted electrostatic capacitance or the like between the antenna and the surrounding metal components.

In general, a wireless device is subjected to testing determined by law and requires approval for use. However, often a fluctuation in characteristics ascribable to the implementation environment differs from product to product. Consequently, in a case where wireless modules serving as functional components are installed sequentially in products having differing mechanical configurations, there are instances where performance deteriorates, for the above-mentioned reasons, with the exception of specific products optimized at the start.

A patch antenna is such that its antenna characteristic is comparatively resistant to fluctuation even from the effects of the surrounding environment, but this does not mean there is no fluctuation at all. In a case where common use of a patch antenna is made in multiple products, therefore, adjustment conforming to the implementation environment of each individual product is still required in the end. As an example of a method of performing a characteristic adjustment per each mounted product at a plurality of frequencies, Japanese Patent Laid-Open No. 11-251827 describes a technique in which, by adopting a screw-type structure for the power-supply pin of a patch antenna, it is possible to adjust the capacitance component at the power-supply point and to subsequently adjust frequency fluctuation after implementation of the device.

Although the technique set forth in Japanese Patent Laid-Open No. 11-251827 relies upon an arrangement in which adjustment of the capacitance component of a matching circuit is made possible subsequently, this results in a change in the structure of the power-feed line per se that constitutes the patch antenna element. Accordingly, in a case where such an antenna is mounted in a plurality of products, a problem which arises is that individual patch antenna elements that incorporate individual adjustments must be prepared.

The present invention has been devised in view of the foregoing problems and provides a technique that makes it possible to use the same antenna element and wireless unit in different products.

### SUMMARY OF THE INVENTION

According to one aspect of the present invention, there is provided an antenna device comprising: a patch antenna element having a conductor plate, a ground conductor plate provided in opposition to one face of the conductor plate and spaced a predetermined distance away from this face, and a power-supply point for supplying electric power to the conductor plate; and at least one additional conductor plate high-frequency coupled to the ground conductor plate and having a shape that extends in a direction orthogonal to a straight line connecting the center of the conductor plate and the power-supply point.

Further features of the present invention will become apparent from the following description of exemplary embodiments with reference to the attached drawings.

### BRIEF DESCRIPTION OF THE DRAWINGS

FIGS. 1A to 1C respectively illustrate an antenna device having a patch antenna element and an additional conductor plate, the antenna element alone and an additional metal plate;

FIG. 2 illustrates a resonance characteristic exhibited by a patch antenna alone;

FIGS. 3A and 3B respectively illustrates an implementation condition in which a metal in nearby and an antenna characteristic under this condition;

FIG. 4 illustrates an example in which an antenna characteristic is improved by addition of a metal plate under a condition in which a metal is nearby;

FIGS. 5A and 5B respectively illustrate the configuration of an antenna device and a change in the antenna characteristic in a case where length of an additional conductor plate is adopted as a parameter;

FIGS. 6A and 6B respectively illustrate another mode of adding a metal plate and an antenna characteristic under this condition;

FIG. 7 illustrates an example of the configuration of an antenna device having a patch antenna element and an additional conductor plate of variable width;

FIGS. 8A to 8D illustrate changes in antenna characteristic in a case where the width of an additional conductor plate is varied;

FIGS. 9A and 9B illustrate another example of an implementation condition of an antenna device in which a metal is in the vicinity;

FIG. 10 illustrates an antenna characteristic under the implementation condition of FIGS. 9A and 9B;

FIGS. 11A and 11B respectively illustrate the overall configuration of an antenna to which an additional conductor plate has been added and the antenna characteristic in such case;

FIG. 12 illustrates another example in which the antenna characteristic is improved by addition of a metal plate under a condition in which there is a metal in the nearby vicinity; and

FIG. 13 is a diagram schematically illustrating an example of the configuration of a wireless communication apparatus having an antenna device according to each embodiment.

### DESCRIPTION OF THE EMBODIMENTS

An exemplary embodiment(s) of the present invention will now be described in detail with reference to the drawings. It should be noted that the relative arrangement of the components, the numerical expressions and numerical values set forth in these embodiments do not limit the scope of the present invention unless it is specifically stated otherwise.

The antenna device described below is provided in various kinds of wireless communication apparatus. Here a wireless communication apparatus refers to all apparatuses having a wireless communication function, such as a camera, printer and facsimile machine. FIG. 13 illustrates the configuration of a wireless communication apparatus having an antenna device according to each embodiment set forth below.

A wireless communication apparatus 1301 includes, for example, a control unit 1302, a storage unit 1303, an input unit 1304, a display unit 1305, a wireless unit 1306 and an antenna device 1307. It should be noted that this arrangement is one example, and the wireless communication apparatus 1301 may have some of the above-mentioned functions removed from it or may have further functions added on.

The control unit 1302, which is a computer such as a CPU or MPU, controls the overall apparatus by executing a control program stored in the storage unit 1303. The storage unit 1303 stores various information such as the control computer program executed by the control unit 1302. The storage unit 1303 can employ a memory such as a ROM or RAM or a flexible disk, hard disk, optical disk, magnetic-optical disk, CD-ROM, CD-R, magnetic tape, non-volatile memory card or DVD. The input unit 1304 is an interface for allowing the user to make various inputs. The display unit 1305, which presents various indications, provides an output of information capable being perceived visually, as in the manner of an LCD or LED, or an output of audio as in the manner of a speaker or the like. By way of example, the wireless unit 1306 converts data, which is generated by the control unit 1302, to the form of a wireless signal and inputs the signal to the antenna device 1307. Further, by way of example, the wireless unit 1306 extracts a signal from radio waves received by the antenna device 1307 and transfers the extracted signal to the control unit 1302. The antenna device 1307 is a device described in each of the embodiments set forth below.

### <<First Embodiment>

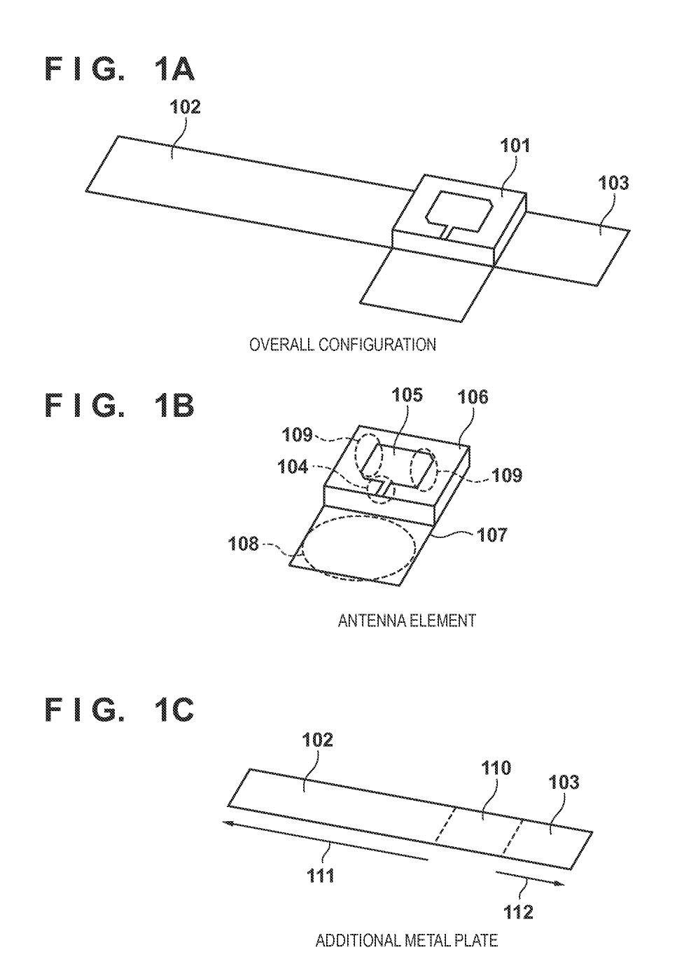

FIGS. 1A to 1C illustrate an example of the configuration of an antenna device according to this embodiment, in which FIG. 1A is a diagram showing the overall antenna device constructed by stacking a patch antenna element 101 on additional conductor plates 102 and 103.

FIG. 1B illustrates in detail an example of the structure of the patch antenna element 101. The patch antenna element 101 is a circularly-polarized patch antenna that operates for example in the 2.4-GHz band. The patch antenna element 101 has a feed line 104, a patch conductor 105, a ceramic block 106 and a ground conductor plate 107. The feed line 104 is a signal input/output line for signals to and from the antenna and is connected to the patch conductor 105, which is the main constituent for resonance operation. The ceramic block 106 is a block of a ceramic having a high specific inductivity on the order of 40 to 100. Owing to the ceramic block 106, a wavelength shortening effect is obtained in proportion to the square root of the specific inductivity of the ceramic material. This makes it possible to reduce the size of the overall patch antenna element. The ground conductor plate 107, which is a conductor plate that functions as ground, is placed opposing one face of the patch conductor 105 and is spaced away from this face by a prescribed distance which, for example, is the thickness of the ceramic block. The ground conductor plate 107 has an area, which is necessary as the antenna, that forms a portion in contact with the lower face of the ceramic block 106. This embodiment, however, illustrates an example that assumes a patch antenna mounted on the substrate of a wireless module, in which the ground conductor plate 107 includes an area 108 for mounting a wireless-function component. No description is given relating to the specific shape of individual components and the like.

In general, the resonant conductor (patch conductor 105) of the patch antenna requires a length and width that are one-half of the wavelength of the resonant frequency. Here “length” refers to the side, namely portion 109 in FIG. 1B, that is parallel to the feed line, and “width” refers to the side orthogonal to the feed line and to portion 109 in FIG. 1B. The length is mainly associated with the center frequency of resonance, and the width is mainly associated with the frequency bandwidth in which resonance is possible. Since wavelength in the 2.4-GHz band is approximately 120 mm, a value on the order of 60 mm (millimeters)×60 mm is required as the element length of the antenna. In this embodiment, however, the antenna is implemented at 1/10 the dimensions by making the specific inductivity of the ceramic block 106 on the order of 100 and obtaining the wavelength shortening effect. By achieving such a size reduction, the dimensions of the module substrate inclusive of the area 108 for mounting the wireless-function component can be made on the order of 20 mm×10 mm.

FIG. 1C illustrates an example of an additional conductor plate. In terms of structure, the additional conductor plate is used upon being affixed to the ground conductor plate 107 of the patch antenna element 101. The structure is such that the additional conductor plate has two additional conductor plates 102 and 103 as portions that project from the ground conductor plate 107 of the patch antenna element 101 when they are affixed. It should be noted that although it is described below that the additional conductor plates 102 and 103 are high-frequency-coupled to the ground conductor plate 107, one of the additional conductor plates may have a length of 0 mm. In other words, it will be sufficient if at least one additional conductor plate is added on.

In this embodiment, the additional conductor plate is described as having such a shape that it is connected to one side of the ground conductor plate 107 that is parallel to a straight line connecting the power-supply point (feed line 104) and the center of the patch conductor 105. For example, even in a case where the shape of the ground conductor plate 107 is not rectangular, it will be sufficient if the additional conductor plate is high-frequency-coupled to the ground conductor plate 107 and has such a shape that extends in a direction orthogonal to, or substantially orthogonal to, a straight line connecting the power-supply point and the center of the patch conductor 105. In this specification, claims and drawings, “orthogonal” is taken to include “substantially orthogonal” unless specifically stated otherwise.

The material constituting the additional conductor plate is, for example, a member exhibiting electrical conductivity and although an aluminum plate or the like may be used in view of cost considerations and the like, the plate is not limited to an aluminum plate. In FIG. 1C, the two additional conductor plates 102 and 103 have a unitary structure in which they are connected via an area 110 for high-frequency coupling. The high-frequency-coupling area 110 is a portion affixed to the ground conductor plate 107 of patch antenna element 101. Adopting a unitary structure in this manner facilitates affixation. However, as long as the structure is one that assures high-frequency coupling, the structure adopted may be one in which the additional conductor plates 102 and 103 are affixed to the ground conductor plate 107 individually. By adjusting lengths 111 and 112 of the additional conductor plates 102 and 103, respectively, in conformity with the implementation condition, the antenna characteristic will be optimized under this implementation condition. That is, any change in the resonance characteristic due to metal members in the vicinity is compensated for by the additional conductor plates 102 and 103 so that the antenna characteristic will approach the target characteristic. A specific method of making such an adjustment will be described later.

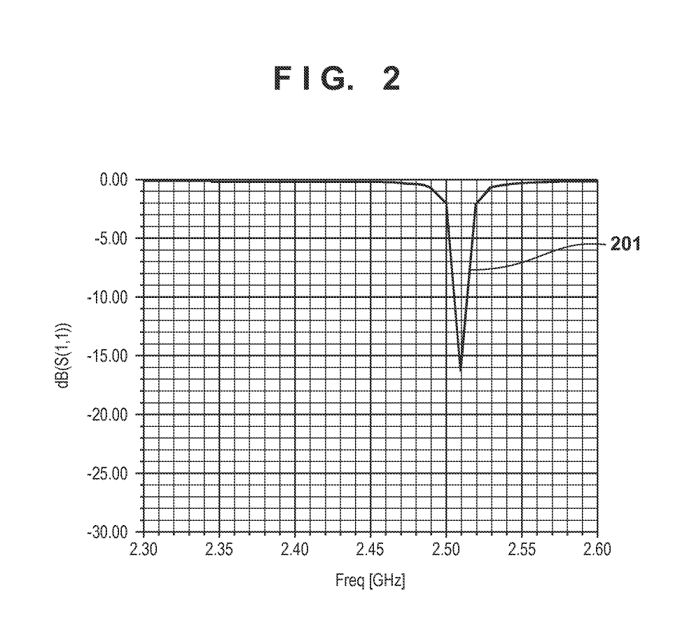

The antenna characteristic in this embodiment will be described next. FIG. 2 illustrates the result found by simulating the resonance characteristic at the stand-alone patch antenna element 101 of FIG. 1B. Here the horizontal axis is a plot of frequency and the vertical axis indicates the antenna resonance characteristic as return loss of the S-parameter S11. If the S11 characteristic is less than −10 dB, the antenna element will exhibit an excellent state of resonance. Curve 201 in FIG. 2 indicates a maximum resonance of −16 dB at 2.51 GHz and shows manifestation of an excellent characteristic.

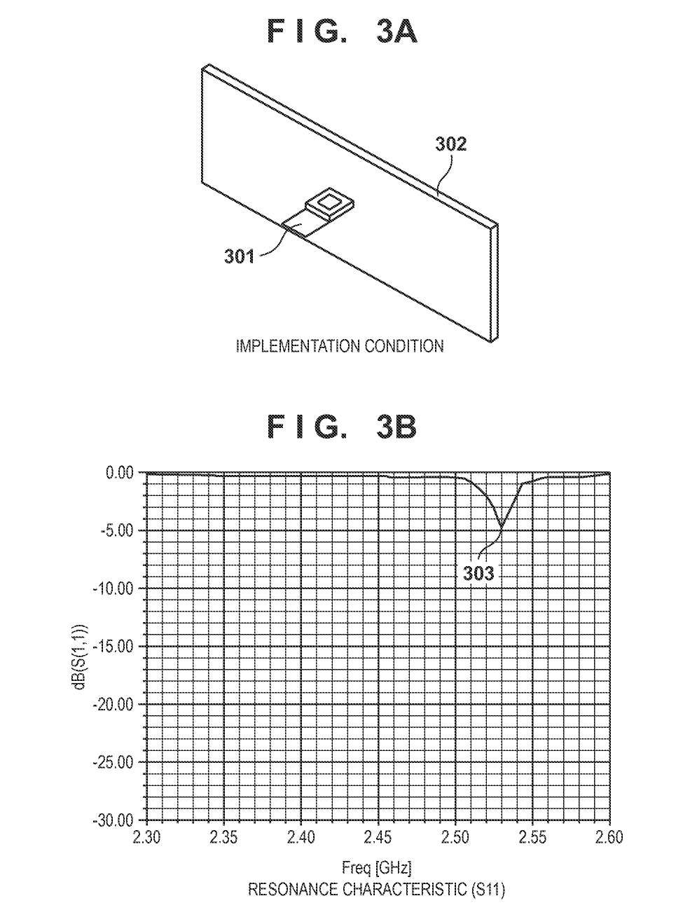

In a case where this antenna is actually mounted in a product, a characteristic similar to that shown in FIG. 2 will be maintained for each product if there are no nearby metal members in the vicinity of the antenna. However, depending upon the surrounding mechanical arrangement, the characteristic at installation in a specific product may deteriorate and individual fluctuations in resonance frequency may occur. FIGS. 3A and 3B illustrate results obtained when an example in which a variation in characteristic due to nearby metal occurred was inspected by a simulation. In the simulation of FIGS. 3A and 3B, a nearby-metal condition was assumed in which a metal wall 302 was placed at a location 2 mm from the side face of a patch antenna element 301, as shown in FIG. 3A. The resonance characteristic in such case is shown in FIG. 3B. As indicated by curve 303 in FIG. 3B, the resonance characteristic in the 2.4-GHz band in this case is such that return loss deteriorates greatly in comparison with the resonance characteristic of the stand-alone antenna shown in FIG. 2, and it will be understood that the target value of less than −10 dB cannot be attained. Further, it will be understood that the maximum resonance frequency is shifted from 2.51 GHz to 2.53 GHz.

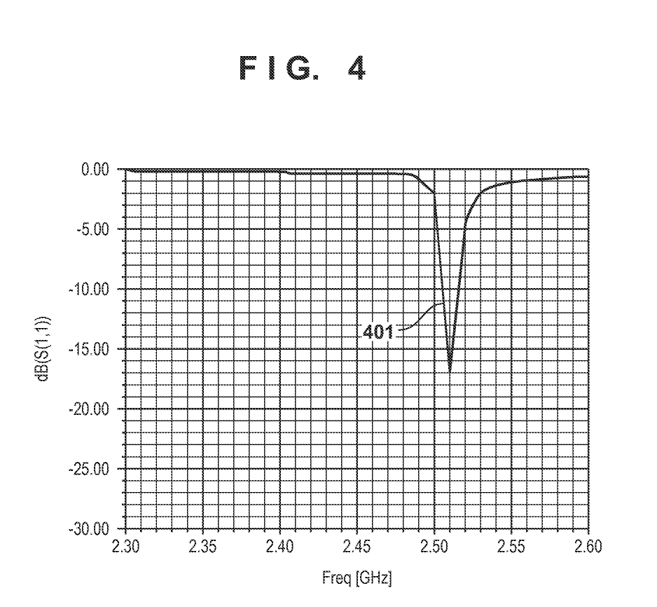

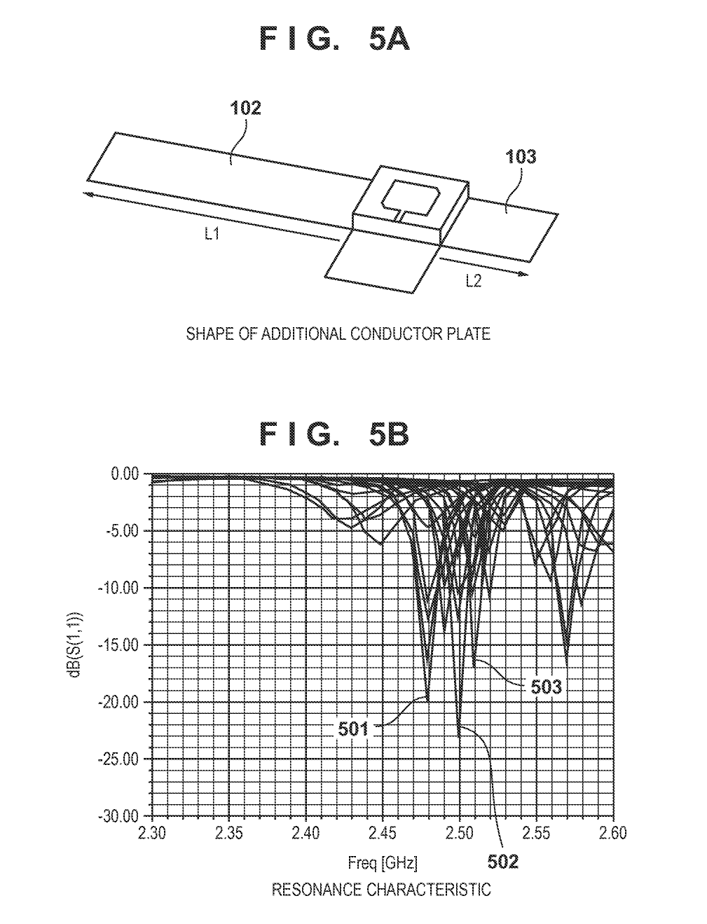

Under the condition of FIG. 3A in which a metal is nearby, the additional conductor plate of the kind shown in FIG. 1C is added to the patch antenna element. FIG. 4 illustrates the antenna characteristic obtained when the additional conductor plate has been added on. Owing to the addition of the metal member, as shown by the curve 401, it will be understood that the 2.4-GHz resonance characteristic is such that the return loss is restored to −17 dB and that the maximum resonance frequency can be returned to 2.51 GHz. It should be noted that in this example, the lengths of the two additional conductor plates are optimized with respect to the nearby-metal condition of FIG. 3A. The optimum lengths of the metal plates will be described with reference to FIGS. 5A and 5B.

As shown in FIG. 5A, assume that L1 represents the length of the additional conductor plate 102 and L2 the length of the additional conductor plate 103. FIG. 5B illustrates a change in return loss when L1 and L2 are changed from 0 to 30 mm at intervals of 5 mm. It will be understood from FIG. 5B that by varying the combination of the lengths of the two additional conductor plates, it is possible to change the resonance-frequency shift and the return loss. For example, curve 501 is for a case where L1 and L2 are made 25 mm and 10 mm, respectively. Although the resonance frequency falls to 2.48 GHz, the return loss reaches −20 dB. Curve 502 is for a case where L1 and L2 are made 5 mm and 25 mm, respectively. Here the return loss reaches −23 dB and the resonance frequency is 2.50 GHz. Curve 503 is for a case where L1 and L2 are made 0 mm and 25 mm, respectively. This is a case where the characteristic obtained is approximately equivalent to that obtained in a state where there is no nearby metal. This is the characteristic shown in FIG. 4. By thus adjusting the dimensions of the two additional conductor plates, it is possible to eliminate the shift in frequency and the deterioration in resonance. For example, the combination of lengths of the metal plates for which the frequency shift is smallest and the return loss smallest is made the combination of lengths that affords the optimum value. In addition, the combination of plate lengths for which return loss is minimized is optimized at the target maximum resonance frequency.

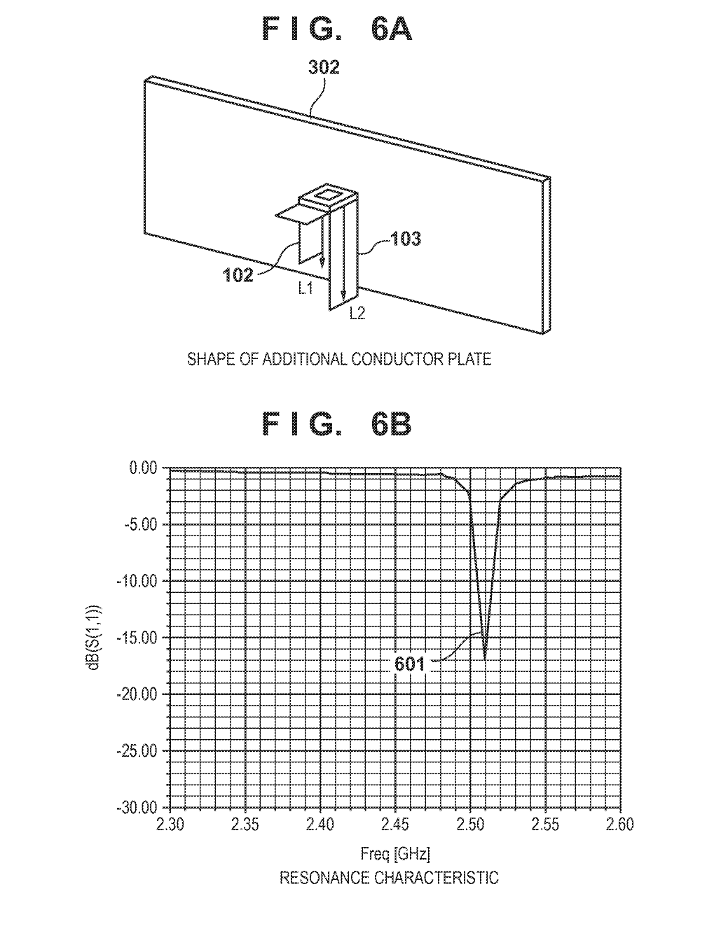

So far a case has been described in which the additional conductor plate has a shape that extends from the periphery of the patch antenna element and in a plane that is parallel to the plane that includes the ground conductor plate 107. However, the invention is not limited to this arrangement. For example, as shown in FIG. 6A, a similar effect can be obtained also by an arrangement in which the two additional conductor plates 102 and 103 extend directly downward from the side faces of the patch antenna. Specifically, the additional conductor plate may have a such shape that the plate extends from the periphery of the patch antenna element 101 toward the side opposite the patch conductor 105 in the direction of the normal to the plane that includes the ground conductor plate 107. Further, the shape need not necessarily be one in which the additional conductor plate extends from the periphery of the patch antenna element 101. That is, the shape may be one in which the additional conductor plate extends from positions nearer to the center of the patch antenna than the side face of the patch antenna.

FIG. 6B illustrates the result of a simulation of the antenna characteristic in a case where L1 and L2 were made 15 mm and 25 mm, respectively, as the result of optimization. This situation is similar to that in which the condition of the nearby metal 302 is as illustrated in FIGS. 3A and 3B. It will be understood from the curve 601 in FIG. 6B that by thus adding on the additional conductor plates, a characteristic substantially equivalent to the characteristic of FIG. 4 can be obtained.

It should be noted that it will be sufficient if the additional conductor plate of this embodiment extends, at least at a portion thereof, in a direction orthogonal to a straight line connecting the center of the patch conductor 105 and the power-feed point; it is not necessary that the plate lie in a single plane. For example, by adopting for the additional conductor plate a flexible substrate structure in which a conductor foil is coated with a polyimide resin or the like, it becomes possible to accommodate curved surfaces as well and it may be arranged so that the additional conductor plate is disposed flexibly in conformity with the structure of components in the vicinity of the mounted portion.

By adopting a structure that is high-frequency coupled to the ground area of a patch antenna element, adding an additional conductor plate to a side face aligned in a direction orthogonal to a feed line and setting the length of the added conductor plate, as described above, the resonance frequency and return loss can be adjusted in conformity with the implementation condition. As a result, by matching impedance, as by simply adding on members, it is possible to restore an antenna characteristic in a patch antenna which originally was optimized as a stand-alone patch antenna element at the time of initial design but which suffered a deterioration in its characteristic owing to metal members being brought into close proximity at the time of product implementation.

### <<Second Embodiment>>

This embodiment will be described in relation to a method of adjusting resonance frequency over a wide range under an implementation condition similar to that of the first embodiment. The patch antenna element 101 in this embodiment has the construction shown in FIG. 1B similar to the first embodiment. The resonance characteristic in the case of the stand-alone patch antenna element 101 of FIG. 1B also is as shown in FIG. 2.

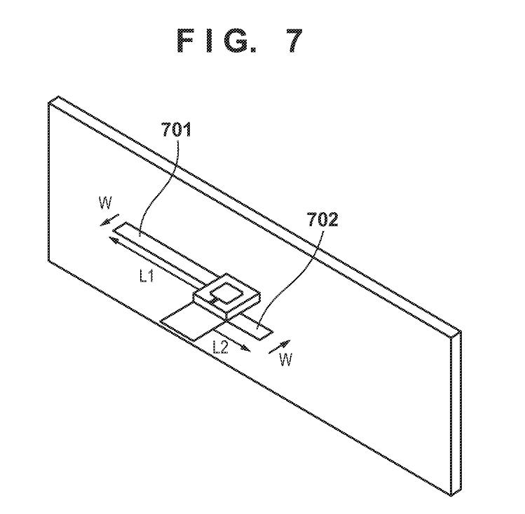

FIG. 7 illustrates the state of the antenna device of the second embodiment, to which the present invention has been applied, at the time of implementation. Although the structure in which two additional conductor plates are added to the patch antenna element is similar to that of the first embodiment, this embodiment differs from the first embodiment in that width W of the additional conductor plates can be varied and set in addition to the lengths L1, L2 of the plates. The starting point of the dimensions when the variable width W is adjusted is a vertex situated on the diagonal line of the rectangular patch structure. That is, two additional conductor plates are placed at positions at the periphery of the patch antenna element 101 having axial symmetry with respect to a normal line to the patch conductor 105. The normal line includes the center of the patch conductor 105. The reason for adopting this arrangement is as follows: Since it is assumed that the antenna device of this embodiment is a circularly-polarized patch antenna, in which the property of the antenna is such that resonance on a radiating conductor of the patch rotates, it becomes possible to adjust the characteristic efficiently by adopting such an axially symmetric placement.

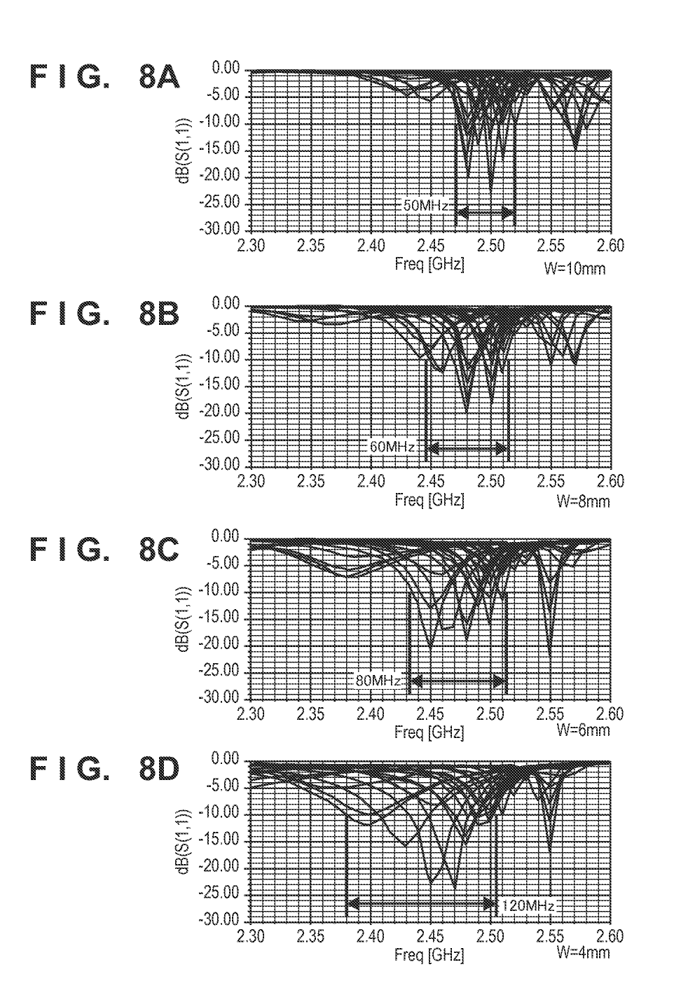

FIGS. 8A to 8D illustrate changes in return loss when, in a case where the variable width W of the additional conductor plates is made 4 mm, 6 mm, 8 mm and 10 mm, respectively, the lengths L1 and L2 of the additional conductor plates are adopted as parameters and are varied from 0 mm to 30 mm at intervals of 5 mm. It should be noted that the width W is 10 mm in case of the condition shown in the first embodiment. A characteristic similar to the characteristic shown in FIG. 5B, therefore, is illustrated in FIG. 8A showing the case where W=10 mm holds. The frequency range where the return loss falls below −10 dB, which is a criterion of excellent operation, is about 50 MHz at this time.

In the first embodiment, the target resonance frequency is fixed and therefore it will be sufficient if the frequency range includes this frequency. In this embodiment, it is assumed that the frequency is varied from the resonance frequency at the stand-alone characteristic to a different value, and broadening this frequency range is considered. In a case where the variable width W of the additional conductor plates is reduced to 8 mm, the frequency range where the return loss falls below −10 dB can be broadened to about 60 MHz, as shown in FIG. 8B, even if the setting of L1 and L2 is performed in a similar manner. Furthermore, in a case where the variable width W is reduced to 6 mm, the frequency range can be broadened to 80 MHz, as shown in FIG. 8C, and in a case where the variable width W is reduced to 4 mm, the frequency range can be broadened to 120 MHz, as shown in FIG. 8D. As a result, frequency adjustment over a wide range is made possible by setting not only the length of the additional conductor plates but also the width thereof in an adjustable manner.

### <<Third Embodiment>>

This embodiment will be described in relation to a method of similarly adjusting resonance frequency under an implementation condition different from that of the first and second embodiments. The patch antenna element 101 in the third embodiment has the construction shown in FIG. 1B similar to that of the first and second embodiments. The resonance characteristic in the case of the stand-alone patch antenna element 101 is assumed to be a characteristic of the kind shown in FIG. 2.

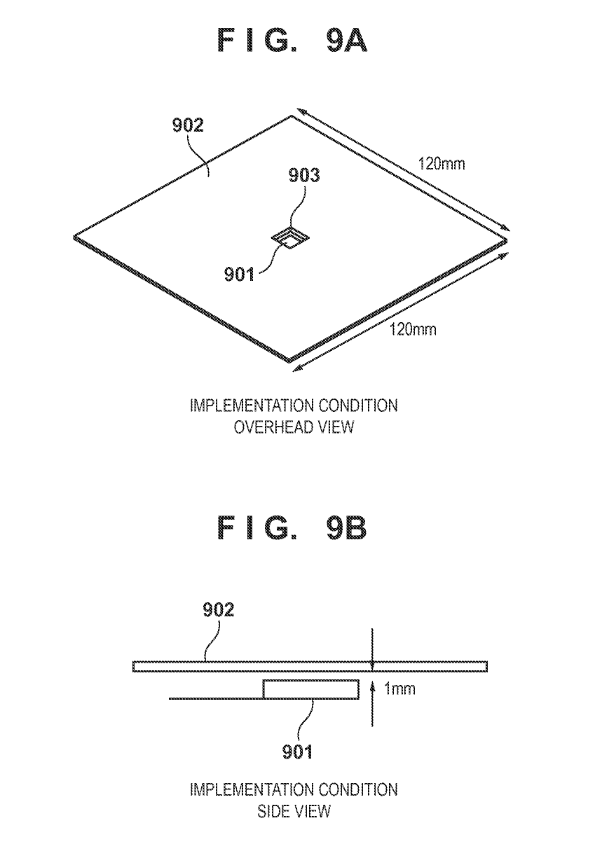

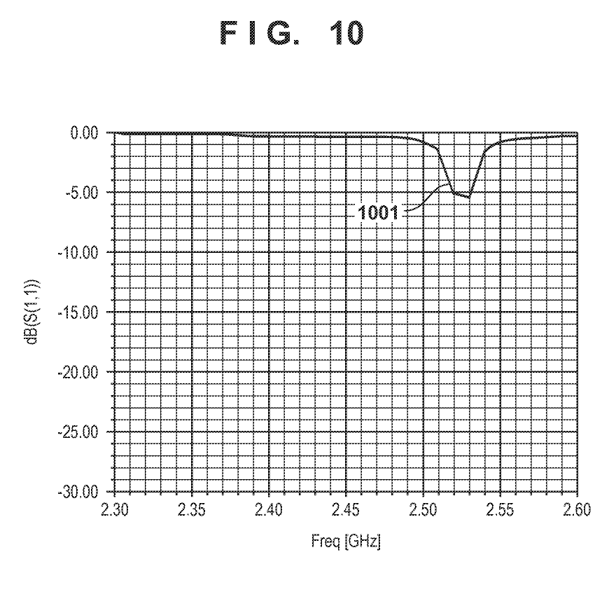

FIGS. 9A and 9B illustrate an example of the implementation condition of an antenna device assumed in this embodiment. Under this implementation condition, a 120-mm square metal plate 902 is placed on the top surface of a patch antenna element 901, and the metal plate 902 has a 10-mm square opening 903 at its center. This is a positional relationship in which the patch antenna element 901 is accommodated directly beneath the opening 903. It is assumed that the distance between the top surface of the patch antenna element 901 and the bottom surface of the metal plate 902 is 1 mm. The antenna characteristic under these conditions is shown in FIG. 10. It will be understood that the resonance characteristic indicated by curve 1001 has deteriorated greatly from the resonance characteristic illustrated in FIG. 2.

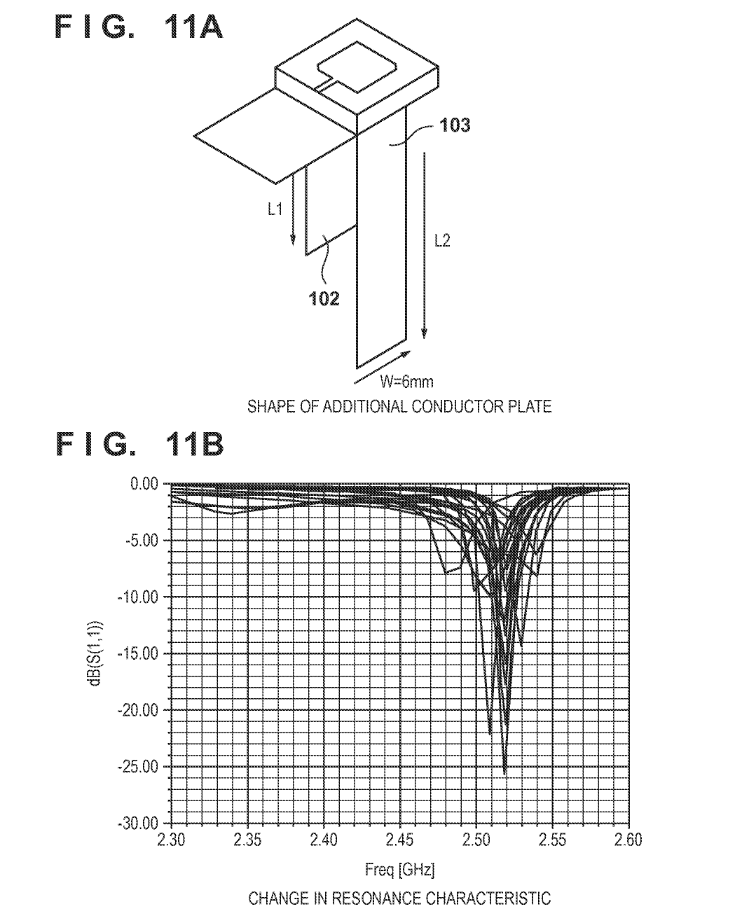

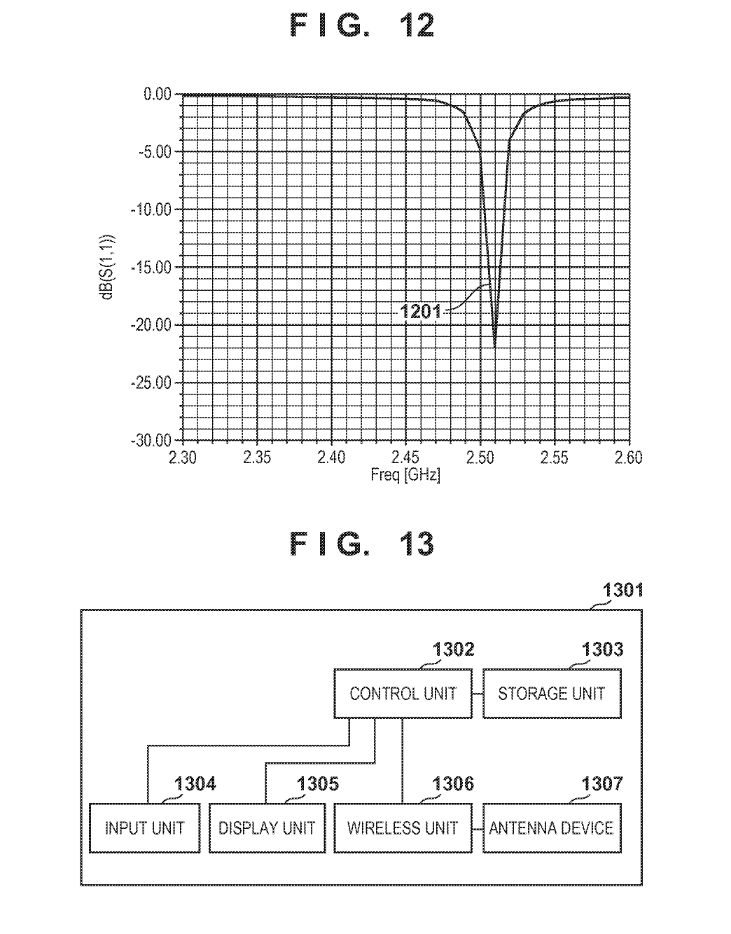

FIGS. 11A and 11B illustrate the state of the antenna device of the third embodiment, to which the present invention has been applied, at the time of implementation. FIG. 11A shows the shape of the overall antenna. In this embodiment, the structure adopted is one in which the additional conductor plates 102 and 103 are extended in a direction orthogonal to the back surface of the patch antenna in a manner similar to that of FIG. 6A. Further, it is assumed that the width W of the additional conductor plates 102 and 103 is 6 mm for both plates. FIG. 11B illustrates a change in the resonance characteristic when the lengths L1 and L2 of the additional conductor plates 102 and 103, respectively, are varied from 5 to 30 mm at intervals of 5 mm. It will be understood from FIG. 11B that by setting the lengths of the two additional conductor plates, it is possible to correct the resonance frequency and restore the intensity of resonance. The optimum characteristic obtained as a result of such setting is shown in FIG. 12. It should be noted that the length L1 of the additional conductor plate 102 is set to 10 mm and the length L2 of the additional conductor plate 103 is set to 30 mm for obtaining this characteristics. It will be understood from FIG. 12 that by adopting the antenna shape as shown in FIG. 11A and setting the dimensions of the two metal plates appropriately, it is possible to eliminate the shift in frequency and the deterioration in resonance.

In each of the foregoing embodiments, a case is described in which the feed line 104, such as a microstrip line, is in the same plane as that of the patch conductor 105. However, use may be made of electric power supply by pin, in which a pin such as a coaxial cable that passes through the ceramic block is connected to the patch conductor 105 to supply it with electric power. In the case of electric power supply by pin, the pin is connected to a location offset from the center of the patch conductor 105, and the additional conductor plates 102 and 103 are added on in a direction orthogonal to or substantially orthogonal to a straight line connecting the pin-connection location and the center of the patch conductor 105. That is, current flows within the patch conductor 105 with bilateral symmetry with respect to a straight line connecting the power-supply point and the center of the patch conductor 105, and the additional conductor plates are added on with respect to the left-right direction. This compensates the resonance characteristic efficiently and makes it possible to obtain the target antenna characteristic.

In accordance with the present invention, it is possible to provide an antenna device in which a target antenna characteristic can be obtained using the same antenna element irrespective of mechanical constituent members in the vicinity of the antenna mounting portion.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2012-120139 filed on May 25, 2012, which is hereby incorporated by reference herein in its entirety.

What is claimed is:

1. An antenna device comprising:
a patch antenna element having a conductor plate, a ground conductor plate provided in opposition to one face of the conductor plate and spaced a predetermined distance away from this face, and a power-supply point for supplying electric power to the conductor plate; and
at least one additional conductor plate high-frequency coupled to the ground conductor plate and having a shape that extends in a direction orthogonal to a straight line connecting the center of the conductor plate and the power-supply point.

2. The device according to claim 1, wherein said additional conductor plate has a shape that extends in a plane parallel to a plane that includes the ground conductor plate.

3. The device according to claim 1, wherein said additional conductor plate has a shape that extends toward a side opposite the conductor plate in the direction of a normal to a plane that includes the ground conductor plate.

4. The device according to claim 1, wherein said device has two of said additional conductor plates; and
said two additional conductor plates have a shape such that they extend from positions which are mutually axially symmetric with respect to a normal to the conductor plate wherein the normal includes the center of the conductor plate.

5. The device according to claim 1, wherein said additional conductor plate has a coupling area for high-frequency coupling to the ground conductor plate; and
said additional conductor plate and the ground conductor plate are high-frequency coupled by adhering the coupling area and the ground conductor plate together.

6. The device according to claim 1, wherein at least any of length, width and position of the ground conductor plate is set in accordance with implementation condition of the antenna device in such a manner that input impedance is matched in the resonance frequency of said patch antenna element.

7. A wireless communication apparatus having the antenna device set forth in claim 1.
